(19) United States
(12) Patent Application Publication
(10) Pub. No.: US 2002/0129503 A1
(43) Pub. Date: Sep. 19, 2002

(54) Manually adjusted stage with nanometer digital readout

(75) Inventors: Stephen J. Botos, Pittsburgh, PA (US); Alexander R. Weibel IV, Coraopolis, PA (US); Eric J. Berdes, Pittsburgh, PA (US); Anthony E. Castle, Pittsburgh, PA (US)

Correspondence Address: David C. Hanson, WEBB ZIESENHEIM LOGSDON ORKIN & HANSON, P.C., 700 Koppers Building, 436 Seventh Avenue, Pittsburgh, PA, 15219, US

(73) Assignee: Aerotech, Inc., Pittsburgh, PA (US)

(21) Appl. No.: 09/811,816

(22) Filed: Mar. 19, 2001

(51) Int. Cl. G01B 5/00

(52) U.S. Cl. 33/1 M

(57) ABSTRACT

A stage assembly includes a first element and a second element. A coarse and fine adjustment mechanism is attached to the first element and engages the second element. Turning either a coarse or fine range selector produces relative movement of the second element in relation to the first element. An encoder is attached to the first element and the second element. The encoder detects movement of the second element in relation to the first element and determines the position of the second element from a home position. A display electrically connected to the encoder displays the position of the second element. A multiplier may be electrically connected to the encoder to partition a digital signal from the encoder to improve the resolution of the adjustment mechanism.

### BACKGROUND OF THE INVENTION

1. Field of the Invention

The present invention relates to an adjustable stage assembly having adjustment and positioning mechanisms through which both coarse and fine adjustments can be made and a display that indicates a relative position of the stage.

2. Description of the Current Art

There are numerous applications in manufacturing and research environments where tools or fixtures need to be placed in highly accurate and repeatable positions for long periods of time, for example, the alignment of an optic in a beam path or setting the focus of a camera or laser. These applications, to date, have not used automated equipment because the length of travel is relatively small (less than 50 mm), the frequency of adjustment is usually low, and typical automated stages are expensive and large in size compared to the devices being manipulated. Therefore, manual positioning stages are utilized in these applications.

Manual stages are relatively simple in design. They include a base, linear bearings, a moving carriage, a spring pre-load element, and a micrometer. The lack of complexity enables these devices to be small in size and cost effective to manufacture.

The current design of these devices has several shortcomings that are mostly related to the micrometer being used as a drive element for the stage. A micrometer is fundamentally a screw that, when turned, threads itself into and out of a stationary “nut”. In the current manual stage design, as the micrometer (the screw) is turned in one direction, the stage moves away from the micrometer. As the micrometer is turned in the other direction, the stage moves toward the micrometer. The threads per inch of the screw defines the resolution of the micrometer. Typical values are on the order of 50 threads/inch or 2 threads/mm.

The problems associated with this drive mechanism are low speed, low sensitivity, and low repeatability. As the number of threads per inch increases, each turn of the micrometer moves the stage a smaller distance. At 50 threads/inch, a micrometer must make 50 revolutions to traverse one inch. Large displacements in distance become time consuming and tedious. Additionally, the sensitivity of micrometers is directly related to the threads per inch. High resolution micrometers have a sensitivity, measured as the smallest repeatable incremental displacement, on the order of a micron. These displacements are indicated by graduations placed along the circumference of the micrometer. The shortcomings of these graduations are that the position is only repeatable to the resolution of the graduation. A position midway between graduations cannot be consistently reproduced.

Some micrometers have an integrated digital readout. However, the resolution of the display, naturally, is limited to the resolution of the micrometer. Therefore, these devices do not overcome the fundamental inability to position with sub-micron accuracy. What the device does offer is an alternative to reading the graduations of the micrometer to determine the current setting.

A growing requirement of the semiconductor and fiber optic industries is for positioning in the nanometer range. For applications requiring nanometer scale positioning, resolution, and repeatability, micrometers are unacceptable.

I developed an alternative to the standard micrometer as the manual-positioning element. The device, disclosed in U.S. Pat. No. 3,727,471 (hereinafter the '471 patent) and incorporated herein by reference, is based on a differential screw principle. A differential screw has a single barrel with threads of differing pitch. When the barrel is rotated, the resultant motion is the difference between the pitch of the two threads. The invention of the '471 patent improved on this principle by adding coarse and fine adjustment capability. Preferably, the device includes a 39 threads/inch and a 40 threads/inch screw. When the coarse adjustment is rotated, the displacement is proportional to the 40 threads/inch screw (i.e., one revolution is 1/40^{th} of an inch). When the fine adjustment is rotated, the displacement is proportional to the difference between the two thread pitches, 1/39−1/40=0.000641 inch. The device, therefore, has the capability of rapid movement with the coarse adjustment and high resolution with the fine adjustment. This differential screw drive mechanism has demonstrated sensitivity down to the 20 nanometer range.

The device of the '471 patent has been incorporated into stage assemblies used for adjusting and positioning items on the stage. A disadvantage of a stage incorporating the '471 device, or another positioning mechanism, is that the same shortcomings concerning repeatability inherent to the micrometer (discussed above) are present. Position is only repeatable to the resolution of the graduation. A position midway between graduations cannot be consistently reproduced. In other words, the relative position of the stage from a known zero (or home) position is unknown during use of the device. While the graduations provide mechanical indications of displacement during use (i.e., indications of the position of the screws in relation to each other), the device does not have the capability to allow the user to position the stage and then significantly move the stage and be able to return to the same position.

### SUMMARY OF THE INVENTION

It is an advantage, according to the present invention, to provide a stage assembly that incorporates a known manual adjusting and positioning mechanism capable of coarse and fine adjustment, while providing a digital readout that indicates the position of the stage from a known zero (or home) position.

The present invention incorporates a high-resolution linear encoder with a differential screw based manual stage (for horizontal linear motion, vertical linear motion, or rotary motion). The encoder output is interfaced to a position display device that has integrated resolution multiplication electronics providing a display resolution, for example, down to 10 nanometers. With the integrated encoder and position display, it is possible to achieve a repeatable (as measured by the display), manually adjusted position, for example, on the order of 20 nanometers.

One of the largest markets for this product is in the fiber optic industry. The small size of the fibers (down to 9 microns in diameter) requires the ability to position in the sub-micron range. Manual positioning stages are used extensively for setup and alignment of fibers and devices under test. The addition of the position feedback display provides the ability to return to known repeatable positions.

### BRIEF DESCRIPTION OF THE DRAWINGS

FIG. 1 is a perspective view of a linear stage assembly according to one embodiment of the present invention;

FIG. 2 is a view partly in cross section of a coarse and fine adjustment mechanism for effecting horizontal linear movement;

FIG. 3 is a view partly in cross section of a coarse and fine adjustment mechanism for effecting vertical linear movement;

FIG. 4 is a top view of a linear stage according to another embodiment of the present invention with an attached coarse and fine adjustment mechanism;

FIG. 5 is a partial cross section side view of the first element and coarse and fine adjustment mechanism shown in FIG. 4;

FIG. 6 is a partial cross section bottom view of the first element and coarse and fine adjustment mechanism shown in FIG. 4;

FIG. 7 is a bottom view of a second element with an attached coarse and fine adjustment mechanism;

FIG. 8 is a partial cross section side view of the second element and coarse and fine adjustment mechanism shown in FIG. 7;

FIG. 9 is a partial cross section top view of the second element and coarse and fine adjustment mechanism shown in FIG. 7;

FIG. 10 is a partial cross section end view of a linear stage;

FIG. 11 is a perspective view of a rotary stage assembly according to one embodiment of the present invention; and

FIG. 12 is a partial cross section view of a rotary stage according to another embodiment of the present invention.

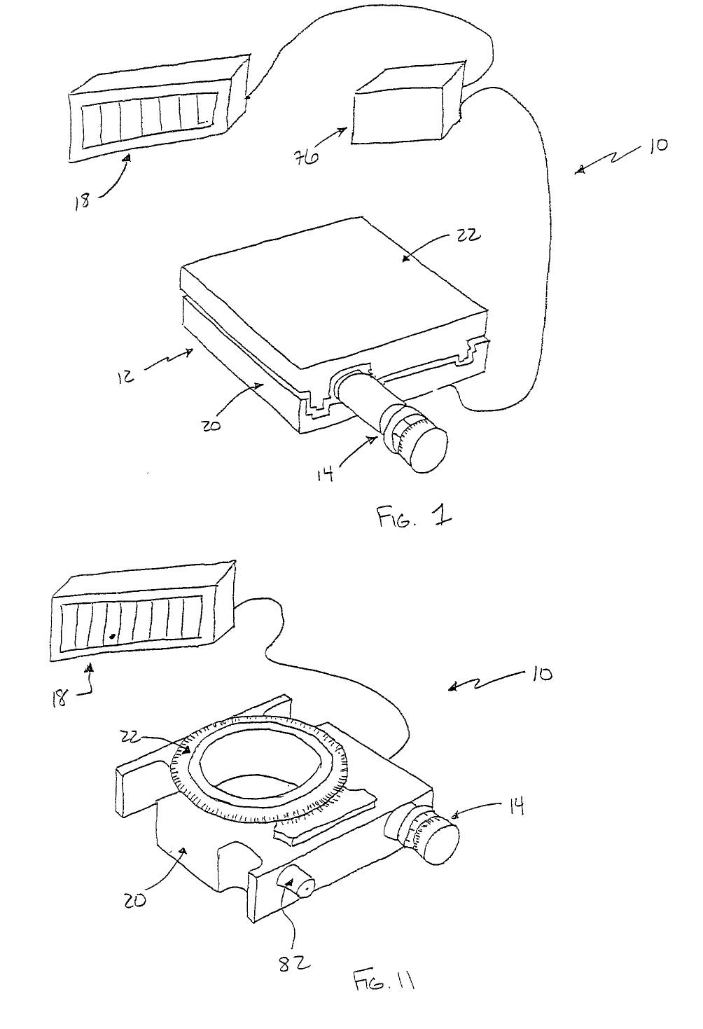

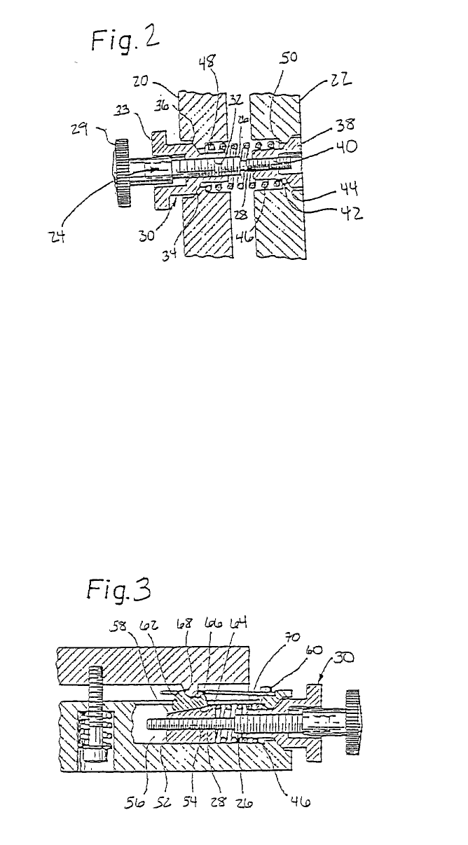

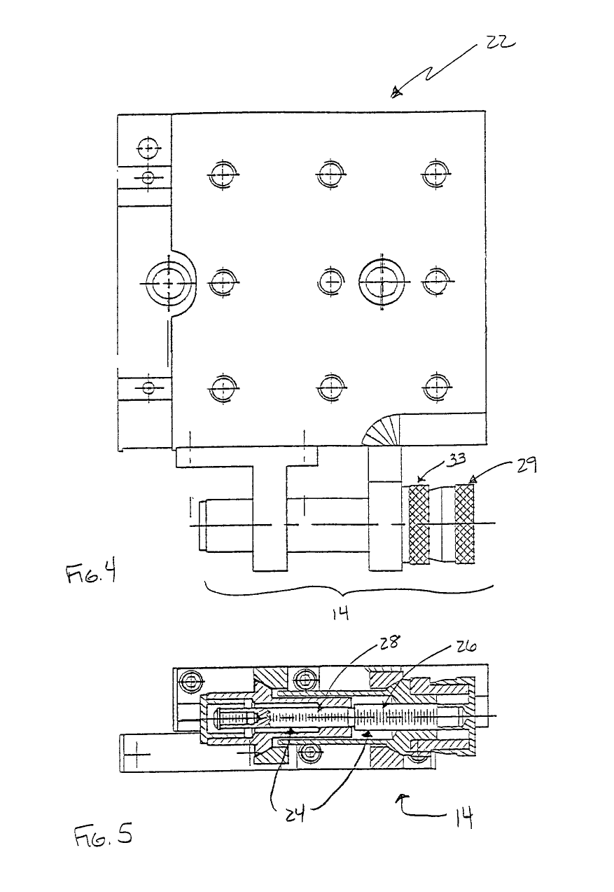

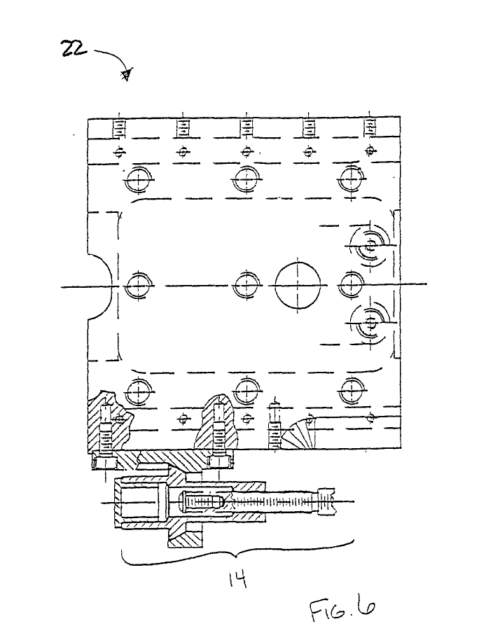

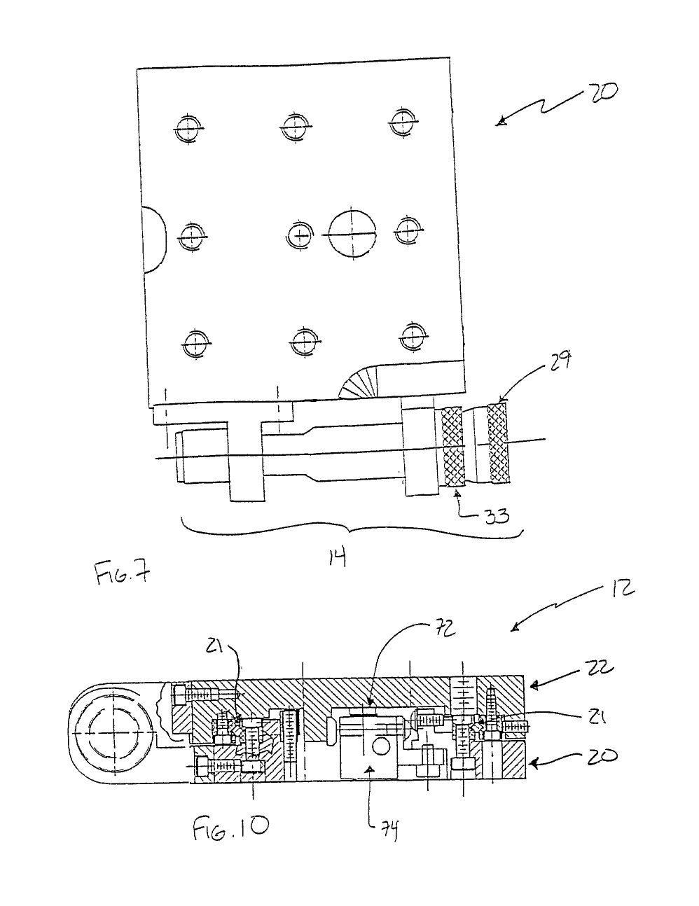

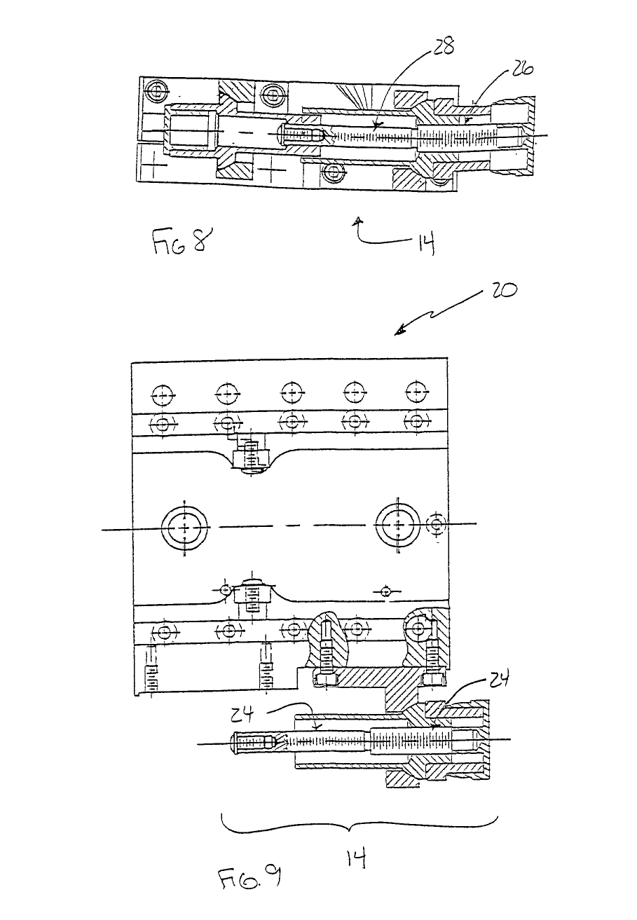

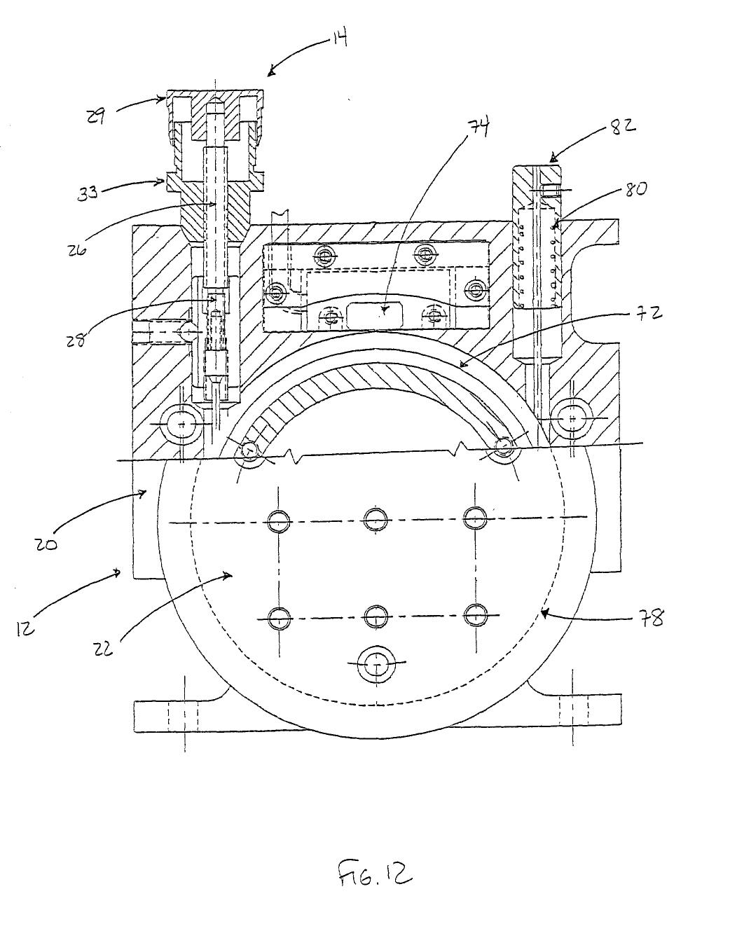

### DESCRIPTION OF THE PREFERRED EMBODIMENTS

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

A stage assembly 10 according to the present invention includes a stage 12, a coarse and fine adjustment mechanism 14, an encoder 16, and a display 18. The stage 12 may be linear or rotary and includes a first element 20 and a second element 22. The first element 20 may be a housing wall, a base plate, or the like. The second element 22 may be a support member for an optical mirror, for example, and is movable in relation to the first element 20. Bearings 21 guide the movement of the second element 22.

In a linear stage assembly according to the present invention, the coarse and fine adjustment mechanism includes a longitudinally extending shaft 24 having two threaded sections 26, 28 of different pitch. A knob 29 is located at one end of the shaft 24. A first stepped cylindrical member 30, referred to as a coarse range selector, has a threaded longitudinally extending bore 32 by means of which it is threadably mounted on one of the threaded sections 26, 28 of the shaft 24. The coarse range selector 30 may have a cylindrical portion 33 to be used as a knob for rotating the coarse range selector 30. One of the steps 34 in the stepped cylindrical member 30 has a generally spherical surface which engages a complementary seating surface 36 in the first element 20. Thus, the stepped cylindrical member 30 is free to rotate and pivot on the seating surface 36.

In a linear stage assembly for effecting horizontal movement of the second element 22 in relation to the first element 20, a second stepped cylindrical member 38 has a threaded longitudinally extending bore 40 by means of which it is threadably mounted on the other threaded section 26, 28 of the shaft 24. Its stepped portion 42 also defines a generally spherical surface which engages a complementary seating surface 44 in the second element 22 located opposite the first element 20. The spherical surfaces of the stepped cylindrical members 30, 38 face one another so that a compression spring 46 positioned about the threaded shaft 24 between the spherical surfaces and bearing at its ends against abutment surfaces 48, 50 in the first and second elements 20, 22, respectively, takes up clearance in the threads and establishes a positive and stable seating relationship between the stepped cylindrical members 30, 38 and the seating surfaces 36, 44 in the two elements 20, 22. This seating arrangement also results in the coarse and fine adjustment mechanism 14 being completely self-aligning.

To effect a coarse adjustment, the coarse range selector 30 is rotated in its seat, resulting in the relative rotation of the shaft 24 in either the selector or the second stepped cylindrical member 38, whichever one is received on the finer threaded section of the shaft 24. Where the selector 30 is mounted on the threaded section of the shaft 24 of a coarser pitch, the threaded shaft 24 turns with the selector 30, resulting in the turning of the shaft 24 in the second stepped cylindrical member 38 which is received on the finer threaded section of the shaft 24 to make the required adjustment. Where the selector 30 is mounted on the threaded section of the shaft of finer pitch, rotation of the selector 30 results in its turning about the shaft 24 to effect the coarse adjustment.

To effect a fine adjustment, the threaded shaft 24 is turned, resulting in the turning of the shaft 24 in both stepped cylindrical members 30, 38, thus, making use of the differential screw principle to achieve the required fine adjustment.

In a linear stage assembly for effecting vertical movement of the second element 22 in relation to the first element 20, an actuating wedge 52 is used in place of the second stepped cylindrical member 38. The wedge 52 has a threaded bore 54 by means of which it is threadably mounted on one of the threaded sections 26, 28 of the shaft 24. The wedge 52 is located within a recess 56 in the first element 20 and has a planar surface 58 which is inclined to the axis of the threaded shaft 24. A compression spring 46 positioned about the shaft 24 between the wedge 52 and the spherical surface of the coarse range selector 30 bears at its ends against the wedge 52 and an abutment surface 60 in the first element 20 to establish a stable seating arrangement for the selector 30.

A ball-like member 62 has a planar surface 64 by means of which it rests on the inclined surface 58 of the wedge 52. Opposite its planar surface 58, the ball-like member 62 is provided with a notch 66 in which rests a projection 68 affixed to the second element 22. A leaf spring 70 positioned over the ball-like member 62 serves to maintain it in place as the wedge 52 moves under it along the threaded shaft 24. Such movement of the wedge 52, depending on the direction of movement, raises or lowers the ball-like member 62 effecting displacement of the second element 22 in a direction perpendicular to the axis of the threaded shaft 24.

The coarse range selector 30 is mounted on the coarser threaded section of the shaft 24. Turning the selector 30 results in the simultaneous turning of the shaft 24. This turning of the shaft 24 in the wedge 52 causes the wedge 52 to move along the shaft 24, resulting in raising and lowering of the ball-like member 62 and the coarse adjustment of the second element 22. Where the selector 30 is mounted on the finer threaded section of the shaft 24, turning of the selector 30 results in its turning about the shaft 24 to effect coarse adjustment. Also, turning of the shaft 24 results in its turning in both the coarse range selector 30 and the wedge 52 causing the wedge 52 to move the shaft 24 according to the difference in the pitches of the threaded sections 26, 28 of the shaft 24. This linear movement is then transferred as fine perpendicular movement to the second element 22.

In the linear stage assembly, the encoder 16 preferably is an optical encoder that includes a tape scale 72 and a digital output readhead 74, for example, a Renishaw® 20-micron pitch tape scale linear encoder. The scale 72 is mounted to either the first element 20 or the second element 22, and the readhead 74 is mounted to the other of the first element 20 or the second element 22. Preferably, the scale 72 is attached to an underside of the movable second element 22 and the readhead 74 is attached to the stationary first element 20.

The scale 72 is scribed with a plurality of substantially equally spaced lines (not shown), or grating. The grating normally has two tracks offset 90 signal degrees apart with respect to each other (in quadrature). A single marker (not shown) on a third track serves as a home marker. The home marker position should be located at the extreme limit of travel closest to the coarse and fine adjustment mechanism 14. This enables the linear stage assembly to be “homed” by pulling the second element 22 toward the coarse and fine adjustment mechanism 14.

The readhead 74 passes light from a lamp or light-emitting diode (not shown) through the grating attached to the second element 22 (i.e., the axis to be measured). The light passing through the grating continues through a reticle or mask (not shown), which together with the grating, acts as a shutter.

As the second element 22 is moved in relation to the first element 20 by turning the coarse and fine adjustment mechanism 14, the encoder 16 senses the passing lines and generates two-channel analog quadrature signals (SIN and COS). These signals are amplified and output as two amplified sinusoids or square waves in quadrature and are output on two separate channels as signals SIN and COS.

With simple incremental encoders 16, the position of the second element 22 in relation to the first element 20 is measured by counting the zero crossings (sinusoidal) or edges (square waves) of both channels. Where greater precision is required, the amplified sinusoidal signals (SIN and COS) are sent to an encoder multiplier 76 where the SIN and COS signals are used to resolve many positions within one grating period (scribe lines). The position is represented by a count which is between zero and the maximum count generated for one SIN or COS signal period. A signal is then either generated from the quadrature pair or separately generated to keep track of which scribe lines the stage 12 is between.

The encoder 16 (or multiplier, if present) is electrically connected to the display 18, for example, a digital readout display. The digital readout display 18 may be an LCD or seven segment display and preferably has a display range of ±00.00001 to ±99.99999 mm. The position of the second element 22 in relation to the first element 20 is displayed on the display 18. Thus, the revolutions of the coarse and fine adjustment mechanism 14 need not be tracked to determine the amount of movement of the stage assembly 10. The user just needs to read the display 18 to know the position of the stage assembly 10.

During use, when the coarse and fine adjustments are made, the distance that the second element 22 moves in relation to the first element 20 is determined. This distance correlates to a position from the home position. With a known position, the stage assembly 10 may be moved from that position and then returned to the same position using the coarse and fine adjustment mechanism 14 until the same position is displayed on the display 18. The encoder position is automatically reset each time the home marker is encountered.

Preferably, the range of the stage assembly 10 is 0.5 inch (13 mm); the coarse resolution (per gradation) is measured in microns; the fine resolution (per gradation) is measured in 0.1 microns; the manual positioning resolution (per 0.5° rotation of fine adjustment) is 0.025 microns; unidirectional repeatability is achieved to the micron; and the encoder 16 resolution is on a 20 micron scale —standard 20 nanometer and optional 10 nanometer resolution with external encoder multiplier electronics.

In a rotary stage assembly for effecting rotational movement of the second element 22 in relation to the first element 20, the second element 22 is a generally circular element rotatably mounted within an opening in the first element 20. A wire 78 is wound circumferentially around the second element 22 at least one complete revolution. One end of the wire 78 is connected to a spring 80 housed in the first element 20. Adjacent the spring 80 is a plunger 82 that extends through an opening in the first element 20. The spring 80 abuts the plunger 82 which maintains the wire 78 taut against the second element 22. When the plunger 82 is actuated, the spring 80 is compressed and the tension of the wire 78 is released. With the plunger 82 actuated, the second element 22 may rotate freely (infinitely). The other end of the wire 78 is connected to the coarse and fine adjustment mechanism 14. Turning the coarse and fine adjustment mechanism 14 results in a corresponding movement of the wire 78. Preferably, the ends of the wire 78 are located at opposed edges of an end of the first element 20.

The coarse and fine adjustment mechanism 14 in the rotary stage assembly includes a longitudinally extending shaft 24 having two threaded sections 26, 28 of different pitch. A stepped cylindrical member 30, referred to as a coarse range selector, has a threaded longitudinally extending bore 32 by means of which it is threadably mounted on one of the threaded sections 26, 28 of the shaft 24. One of the steps 34 in the stepped cylindrical member 30 has a generally spherical surface which engages a complementary seating surface 36 in the first element 20. Thus, the stepped cylindrical member 30 is free to rotate and pivot on the seating surface 36.

A second stepped cylindrical member 38 has a threaded longitudinally extending bore 40 by means of which it is threadably mounted on the other threaded section 26, 28 of the shaft 24. Its stepped portion 42 also defines a generally spherical surface which is attached to the wire 78. The spherical surfaces of the stepped cylindrical members 30, 38 face one another so that a compression spring 46 positioned about the threaded shaft 24 between the spherical surfaces and bearing at its ends against abutment surfaces 48, 50 in the first element 20 and the end of the wire 78 takes up clearance in the threads and establishes a positive and stable seating relationship between the stepped cylindrical members 30, 38 and the seating surfaces 36, 44 in the two elements 20, 22. This seating arrangement also results in the coarse and fine adjustment mechanism 14 being completely self-aligning.

To effect a coarse adjustment, the coarse range selector 30 is rotated in its seat, resulting in the relative rotation of the shaft 34 in either the selector 30 or the second stepped cylindrical member 38, whichever one is received on the finer threaded section of the shaft 24. Where the selector 30 is mounted on the threaded section of the shaft 24 of coarser pitch, the threaded shaft 24 turns with the selector 30, resulting in the turning of the shaft 30 in the second stepped cylindrical member 38 which is received on the finer threaded section of the shaft to make the required adjustment. Where the selector 30 is mounted on the threaded section of the shaft of finer pitch, rotation of the selector 30 results in its turning about the shaft 24 to effect the coarse adjustment.

To effect a fine adjustment, the threaded shaft 24 is turned, resulting in the turning of the shaft 24 in both stepped cylindrical members 30, 38, thus, making use of the differential screw principle to achieve the required fine adjustment.

The encoder 16 is attached to the first and second elements 20, 22, respectively. Preferably, the tape scale 72 is placed around the circumference of the second element 22, and the readhead 74 is mounted to the first element 20. As the coarse and fine adjustment mechanism 14 is turned to rotate the second element 22, the lines on the scale 72 are sensed by the readhead 74 and SIN and COS signals are generated. The scale 72 has a home marker that signifies that a complete revolution of the second element 22 has been made.

An encoder multiplier 76 may again be used to segment the SIN and COS signals into discrete values to increase the resolution of the position of the second element 22 in relation to the first element 20. The display 18 is electrically connected to the encoder 16 or the multiplier 76, if used, and displays the position of the stage assembly 10. The digital readout display 18 may be an LCD or seven segment display and preferably has a display range of 000.00000 to 359.99999°.

Preferably, resolution (per 0.5° rotation of fine adjustment) is measured to 0.1 arc-second; a thimble graduation is measured in 2.54 arc-seconds; a fine resolution (per gradation) is measured in 0.1 microns; and the encoder 16 resolution is on a 20 micron scale —standard 20 nanometer resolution after encoder multiplication, applied at approximately a 2 inch radius would give a resolution of 0.085 arc-seconds (0.000020°).

It will be understood by those skilled in the art that while the foregoing description sets forth in detail preferred embodiments of the present invention, modifications, additions, and changes might be made thereto without departing from the spirit and scope of the invention.

I claim:

1. A stage assembly, comprising:
a first element;
a second element movable in relation to the first element;
a coarse and fine adjustment mechanism attached to the first element and engaging the second element, wherein the coarse and fine adjustment mechanism effects movement of the second element in relation to the first element;
an encoder having a scale and a readhead, the scale attached to the second element, and the readhead attached to the first element, wherein the encoder detects movement of the second element in relation to the first element and determines the position of the second element from a home position; and
a display electrically connected to the encoder, wherein the display displays the position of the second element from the home position.

2. The stage assembly as claimed in claim 1, further including:
a multiplier electrically connected between the encoder and the display, wherein the multiplier divides a digital signal produced by the encoder into discrete sections.

3. The stage assembly as claimed in claim 1, wherein the second element moves in a plane parallel to a longitudinal axis of the coarse and fine adjustment mechanism.

4. The stage assembly as claimed in claim 1, wherein the second element moves in a plane perpendicular to a longitudinal axis of the coarse and fine adjustment mechanism.

5. The stage assembly as claimed in claim 1, wherein the second element rotates within the first element.

6. The stage assembly as claimed in claim 1, wherein the coarse and fine adjustment mechanism includes:
a coarse range selector means having a shoulder for engaging a seat in the first element so as to be free to rotate on the seat about an axis of rotation, without displacement of the shoulder from the seat, the coarse range selector means having a threaded bore coaxial with its axis of rotation,
a longitudinally extending positioner means having longitudinally spaced first and second threaded sections of different pitch, the positioner means extending through the coarse range selector means and the threaded bore of the coarse range selector means being received on the first threaded section of the positioner means, and
adjusting means having an internally threaded bore receiving the second threaded section of the positioner means and cooperating with the second element,
whereby rotation of the coarse range selector means results in the relative rotation of the positioner means in one of the adjusting means or coarse range selector means and the consequent longitudinal displacement of said one of the adjusting means or coarse range selector means along the positioner means to effect a coarse adjustment in the position of the first element relative to the second element, and rotation of the positioner means results in both the longitudinal displacement of the coarse range selector means along the first threaded section of the positioner means and of the adjusting means along the second threaded section of the positioner means to effect a fine adjustment in the position of the first element relative to the second element.

7. The stage assembly as claimed in claim 6, wherein the adjusting means includes:
an actuating wedge having a surface inclined to the longitudinal axis of the positioner means, and
means in contact with the second element and in sliding engagement with the inclined surface,
whereby longitudinal displacement of the actuating wedge along the second threaded section of the positioner means results in the displacement of the engaging means in a direction perpendicular to the direction of the longitudinal displacement.

8. The stage assembly as claimed in claim 6, wherein the adjusting means cooperates with the second element through an end of a wire wound around the second element,
another end of the wire is connected to a spring biased by a plunger, the spring holds the wire taut around the second element,
wherein when the plunger is actuated, the spring compresses allowing the wire to loosen around the second element for free rotation of the second element in relation to the first element.
